(19) United States
(12) Patent Application Publication
(10) Pub. No.: US 2026/0252709 A1
(43) Pub. Date: Aug. 27, 2026

(54) DIAGNOSIS SUPPORT DEVICE, DIAGNOSIS SUPPORT SYSTEM, DIAGNOSIS SUPPORT METHOD, AND STORAGE MEDIUM

(71) Applicant: NEC Corporation, Tokyo (JP)

(72) Inventors: Norio YAMAGAKI, Tokyo (JP); Shunichi KINOSHITA, Tokyo (JP); Mamoru SAITA, Tokyo (JP); Hirofumi UEDA, Tokyo (JP)

(73) Assignee: NEC Corporation, Tokyo (JP)

(21) Appl. No.: 19/419,771

(22) Filed: Dec. 15, 2025

(30) Foreign Application Priority Data
Feb. 27, 2025 (JP) 2025-029661

(51) Int. Cl. G06F 21/57

(52) U.S. Cl. CPC G06F 21/577

(57) ABSTRACT

A diagnosis support device according to an aspect of the present disclosure includes: at least one memory storing a set of instructions; and at least one processor configured to execute the set of instructions to: extract a device characteristic indicating information related to security of a target device from information of the target device; determine, from the device characteristic, a magnitude of a device risk based on a magnitude of a risk of a security item that is a predetermined item related to security, the device risk being a risk that is capable of existing in the target device; and output a magnitude of the device risk.

This application is based upon and claims the benefit of priority from Japanese Patent Application No. 2025-029661, filed on February 27, 2025, the disclosure of which is incorporated herein in its entirety by reference.

### TECHNICAL FIELD

The present disclosure relates to a diagnosis support device, a diagnosis support system, a diagnosis support method, and a program.

### BACKGROUND ART

The importance of grasping the vulnerability of network devices such as switches and routers and devices such as information processing devices is increasing year by year.

JP 2019-114172 A describes an incident response support device or the like that specifies an incident, creates a response procedure relevant to the specified incident, and selects a display range of the response procedure according to a progress status of the response in a case where the incident occurs in the monitoring target.

### SUMMARY

In the technique of JP 2019-114172 A, it is possible to know a procedure relevant to an incident that has occurred. However, with the technique of JP 2019-114172 A, it is not possible to grasp the degree of importance of diagnosis as to whether a security risk actually exists in a monitoring target.

An object of the present disclosure is to provide a diagnosis support device, a diagnosis support system, a diagnosis support method, and a program capable of grasping a degree of importance of diagnosis as to whether a security risk actually exists in a monitoring target.

A diagnosis support device according to an aspect of the present disclosure includes: at least one memory storing a set of instructions; and at least one processor configured to execute the set of instructions to: extract a device characteristic indicating information related to security of a target device from information of the target device; determine, from the device characteristic, a magnitude of a device risk based on a magnitude of a risk of a security item that is a predetermined item related to security, the device risk being a risk that is capable of existing in the target device; and output a magnitude of the device risk.

A diagnosis support method according to an aspect of the present disclosure includes: extracting a device characteristic indicating information related to security of a target device from information of the target device; determining, from the device characteristic, a magnitude of a device risk based on a magnitude of a risk of a security item that is a predetermined item related to security, the device risk being a risk that may exist in the target device; and outputting a magnitude of the device risk.

A non-transitory computer readable storage medium according to an aspect of the present disclosure stores a program for causing a computer to execute: characteristic extraction processing of extracting a device characteristic indicating information related to security of a target device from information of the target device; determination processing of determining, from the device characteristic, a magnitude of a device risk based on a magnitude of a risk of a security item that is a predetermined item related to security, the device risk being a risk that is capable of existing in the target device; and output processing of outputting a magnitude of the device risk.

The present disclosure has an effect of being able to grasp the degree of importance of diagnosis as to whether a security risk actually exists in a monitoring target.

### BRIEF DESCRIPTION OF THE DRAWINGS

FIG. 1 is a block diagram illustrating an example of a configuration of a diagnosis support device according to the present disclosure;

FIG. 2 is a flowchart illustrating an example of operation of the diagnosis support device according to the present disclosure;

FIG. 3 is a block diagram illustrating a configuration of a diagnosis support system according to the present disclosure;

FIG. 4 is a block diagram illustrating a configuration of a diagnosis support device according to the present disclosure;

FIG. 5 is a flowchart illustrating an example of operation of the diagnosis support device according to the present disclosure;

FIG. 6 is a block diagram illustrating a configuration of a diagnosis support device according to the present disclosure;

FIG. 7 is a flowchart illustrating an example of operation of the diagnosis support device according to the present disclosure;

FIG. 8 is a block diagram illustrating a configuration of a diagnosis support device according to the present disclosure;

FIG. 9 is a flowchart illustrating an example of the entire operation of the diagnosis support device according to the present disclosure;

FIG. 10 is a flowchart illustrating an example of an operation of determination processing of the diagnosis support device according to the present disclosure; and

FIG. 11 is a diagram illustrating an example of a hardware configuration of a computer that can implement the diagnosis support device according to the example embodiments of the present disclosure.

### EXAMPLE EMBODIMENT

Hereinafter, example embodiments of the present disclosure will be described in detail with reference to the drawings.

### First Example Embodiment

First, a first example embodiment of the present disclosure will be described in detail with reference to the drawings.

### Configuration

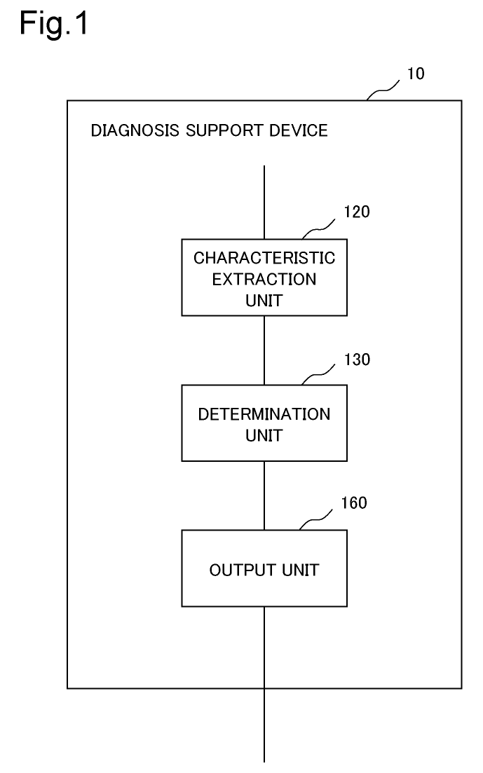

FIG. 1 is a block diagram illustrating an example of a configuration of a diagnosis support device according to the present disclosure.

Hereinafter, a configuration of the diagnosis support device according to the first example embodiment of the present disclosure will be described in detail with reference to FIG. 1.

In the example illustrated in FIG. 1, the diagnosis support device 10 according to one aspect of the present disclosure includes a characteristic extraction unit 120, a determination unit 130, and an output unit 160. The characteristic extraction unit 120 extracts a device characteristic indicating information related to security of the target device from the information of the target device. The determination unit 130 determines the magnitude of the device risk, which is a risk that may exist in the target device, based on the magnitude of the risk for each security item, which is a predetermined item related to security, from the device characteristic. The output unit 160 outputs the magnitude of the device risk.

### Description

The target device is a device for which a device risk is determined. The target device is, for example, an information processing device such as a server or a network device. The information processing device is, for example, an information processing device such as a server. The information processing device may be another information processing device. The network device is a device such as a router or a switch. The target device may be another device.

The information of the target device is, for example, information of any of a type of the target device, a specification of the target device, a function of the target device, how the target device is used, setting of the target device, a state of a measure regarding security of the target device, a management entity of the target device, and the like.

The device characteristic is, for example, information of the target device regarding a predetermined item related to security obtained from any information of a type of the target device, a specification of the target device, a function of the target device, how the target device is used, setting of the target device, a state of a measure regarding security of the target device, a management entity of the target device, and the like. The item is information indicating a certain state related to security. The information of the target device regarding the item is, for example, information indicating whether the target device is in a state indicated by the item.

The risk in the target device is, for example, a risk of an event related to security in the target device, in other words, a risk such as existence or occurrence of an event related to security in the target device. Specifically, the risk in the target device may be, for example, a risk that a vulnerability may exist in the target device. The risk in the target device may be, for example, a risk that the setting of the target device may be a setting leading to vulnerability. The risk in the target device may be a risk that an event (incident) related to security occurs in the target device when any of confidentiality, integrity, availability, and the like of the target device and the information or the like held by the target device is violated by an attack, an accident, or the like. Examples of the incident related to security include a network failure, intrusion from the outside, leakage of various information, and the like. The risk in the target device may be a combination of any of these examples.

A risk that may exist in the target device (that is, device risk) is a risk that may exist in the target device, as determined from device characteristics of the target device. The risk that may exist in the target device is determined based on a state indicated by a security item that is a predetermined item related to security obtained as a device characteristic of the target device. The risk that may exist in the target device can also be rephrased as a risk that may occur in the diagnosis device.

The magnitude of the risk indicates a degree of possibility such as existence or occurrence of an event related to security. The magnitude of the risk may indicate the degree of possibility that an event related to security exists. The magnitude of the risk may indicate a degree of possibility that an event related to security will occur. The magnitude of the risk may be determined such that, for example, the greater the magnitude of the risk, the higher the possibility described above. For example, the magnitude of the risk is predetermined for each predetermined item related to security obtained as device characteristics. The magnitude of the risk may be indicated by a numerical value. The magnitude of the risk may be indicated by a character, a character string, a symbol, a color, or the like indicating the degree of the magnitude.

Specific examples of the information of the target device, the device characteristics, and the device risk will be described in detail in the description of the second example embodiment to be described later.

The output unit 160 outputs the magnitude of the device risk to, for example, a display of the diagnosis support device 10. The output unit 160 may output the magnitude of the device risk to, for example, a terminal device of a user communicably connected to the diagnosis support device 10. The output unit 160 may output the magnitude of the device risk to, for example, another information processing device such as a storage device or a server that can be accessed by the diagnosis support device 10.

### Operation

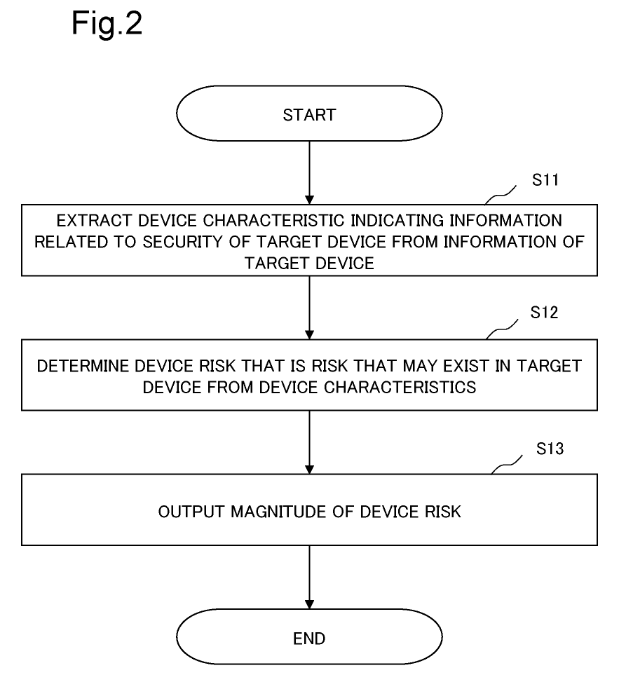

FIG. 2 is a flowchart illustrating an example of the operation of the diagnosis support device according to the present disclosure.

Hereinafter, the operation of the diagnosis support device according to the first example embodiment of the present disclosure will be described in detail with reference to FIG. 2.

In the example illustrated in FIG. 2, the characteristic extraction unit 120 extracts a device characteristic indicating information related to security of the target device from the information of the target device (step S11). The determination unit 130 determines a device risk that is a risk that may exist in the target device from the device characteristics (step S12). In step S12, the determination unit 130 may determine the magnitude of the device risk, which is a risk that may exist in the target device, based on the magnitude of the risk for each predetermined item related to security of the device characteristic from the device characteristic. The output unit 160 outputs the magnitude of the device risk (step S13).

### Effects

The present example embodiment described above has an effect of, for example, grasping the degree of importance of diagnosis as to whether a risk actually exists in a monitoring target.

The reason is that the characteristic extraction unit 120 extracts the device characteristic indicating the information related to the security of the target device from the information of the target device. In the example of the present example embodiment, the monitoring target is, for example, the above-described target device. This is because the determination unit 130 determines a device risk that is a risk that may exist in the target device, from the device characteristics. This is because the output unit 160 outputs the magnitude of the device risk. Generally, in order to maintain the security of the target device, in a case where it is determined that a risk may exist in the target device, a diagnosis is made as to whether the risk actually exists, and if the risk exists as a result of the diagnosis, the risk is removed. Then, as the magnitude of the device risk, which is a risk that may exist in the target device, is larger, it is more important to confirm the presence of the device risk and to remove the device risk in a case where the device risk exists. That is, the larger the device risk, which is a risk that may exist in the target device, the higher the importance of diagnosing whether the device risk actually exists. Based on the magnitude of the device risk, the degree of importance of diagnosing whether the device risk actually exists can be grasped.

### Second Example Embodiment

Next, a second example embodiment of the present disclosure will be described in detail with reference to the drawings.

### Configuration

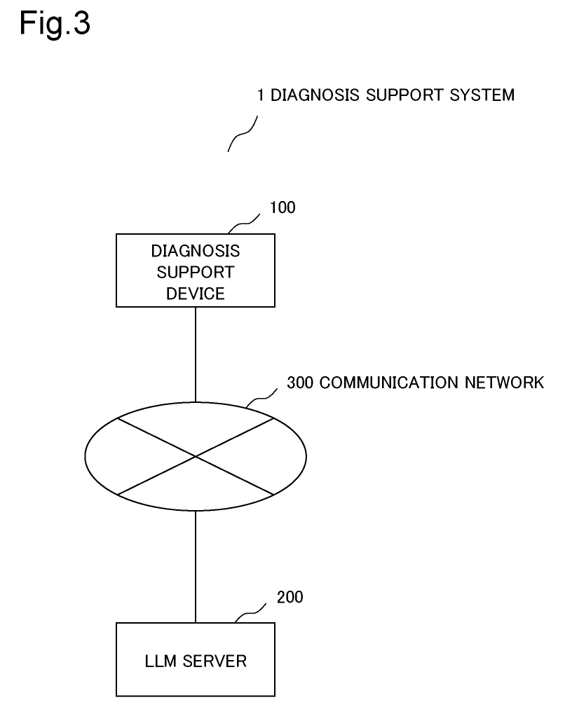

FIG. 3 is a block diagram illustrating a configuration of a diagnosis support system according to the present disclosure.

A configuration of the diagnosis support system according to the second example embodiment of the present disclosure will be described in detail with reference to FIG. 3. The diagnosis support system 1 illustrated in FIG. 3 includes a diagnosis support device 100 communicably connected to a communication network 300. The diagnosis support device 100 may be communicable with the large language model server 200 via the communication network 300. In the following description, the large language model server 200 is referred to as a large language model (LLM) server 200.

### Large Language Model Server 200

The large language model server 200 is a server that provides services based on a large language model (LLM). The service by LLM is, for example, a service that receives an instruction by text, generates an output according to the received instruction by using LLM, and provides the generated output.

In the diagnosis support system 1 illustrated in FIG. 3 in the above description, the diagnosis support device 100 has a configuration physically different from that of the LLM server 200. In other words, the diagnosis support device 100 and the LLM server 200 are implemented as different devices communicably connected to each other. However, the diagnosis support device 100 may be configured to provide a service by LLM. In other words, in the example illustrated in FIG. 3, the function of LLM provided by the LLM server 200 may be implemented in the diagnosis support device 100. The diagnosis support device 100 may also be configured to operate as the LLM server 200.

### Diagnosis Support Device 100

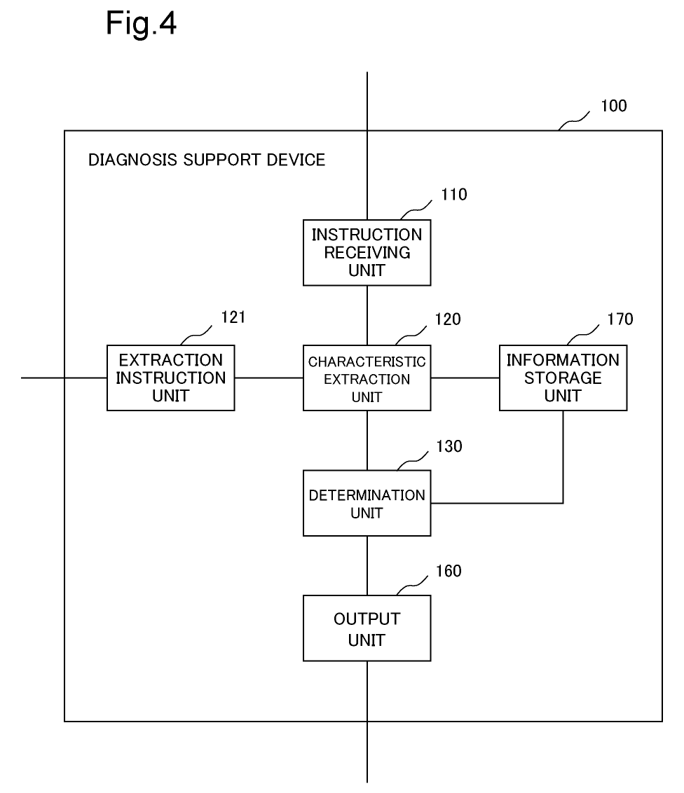

FIG. 4 is a block diagram illustrating a configuration of a diagnosis support device according to the present disclosure.

A configuration of the diagnosis support device according to the second example embodiment of the present disclosure will be described in detail with reference to FIG. 4. In the example illustrated in FIG. 4, the diagnosis support device 100 includes an instruction receiving unit 110, a characteristic extraction unit 120, an extraction instruction unit 121, a determination unit 130, an output unit 160, and an information storage unit 170. The characteristic extraction unit 120, the determination unit 130, and the output unit 160 of the present example embodiment have the same functions as the functions of the characteristic extraction unit 120, the determination unit 130, and the output unit 160 of the first example embodiment.

### Instruction Receiving Unit 110

The instruction receiving unit 110 receives a determination instruction that is an instruction for making a determination related to the target device and information of the target device. The instruction receiving unit 110 may receive a determination instruction including information of the target device. The instruction receiving unit 110 may receive information of the target device as the determination instruction. In other words, the information of the target device may be the determination instruction. The information of the target device is similar to the information of the target device in the first example embodiment. The information of the target device may include information specifying the target device.

### Characteristic Extraction Unit 120

The characteristic extraction unit 120 extracts a device characteristic indicating information related to security of the target device from the information of the target device. The device characteristic is expressed by using, for example, a security item indicating a matter related to security. The matter related to security means, for example, that specific information related to security of the target device is in a specific state. The characteristic extraction unit 120 determines whether the information of the target device indicates a matter indicated by a predetermined security item. Information indicating the relationship between the information of the target device and the predetermined security item is also referred to as characteristic reference data. In the following description, information indicating whether the information of the target device indicates the matter indicated by the security item is referred to as the applicability state of the security item. In other words, the characteristic extraction unit 120 specifies the applicability state of the security item in the information of the target device from the information of the target device. The characteristic extraction unit 120 does not need to specify the applicability states of all predetermined security items. The characteristic extraction unit 120 may specify the applicability state of the security item that can be specified from the information of the target device among all the predetermined security items. As described above, the characteristic extraction unit 120 extracts the device characteristic from the information of the target device by specifying the applicability state of the security item in the information of the target device. The device characteristic in this case is indicated by the applicability state (that is, information indicating whether the information of the target device indicates the matter indicated by the security item) of the security item indicated by the information of the target device, the applicability state being specified from the information of the target device by the characteristic extraction unit 120. More specific examples of the information and device characteristics of the target device will be described in detail later. In the present disclosure, the applicability state of the security item may be simply referred to as a state of the security item.

As will be described later, the characteristic extraction unit 120 may send, to the extraction instruction unit 121, an instruction (hereinafter, also referred to as an execution instruction) to cause the LLM server 200 to execute processing of extracting at least a part of the device characteristic from at least a part of the information of the target device. In this case, the characteristic extraction unit 120 receives the information of the device characteristic from the extraction instruction unit 121 that has received the information of the device characteristic extracted by the LLM server 200. In other words, the characteristic extraction unit 120 receives the information of the device characteristic extracted by the LLM server 200 from the LLM server 200 via the extraction instruction unit 121.

### Extraction Instruction Unit 121

The extraction instruction unit 121 transmits an instruction to execute processing of extracting at least a part of the device characteristics from at least a part of the information of the target device (hereinafter, also referred to as an extraction instruction) to the LLM server 200. For example, the extraction instruction unit 121 transmits the extraction instruction described above to the LLM server 200 in response to receiving the execution instruction described above from the characteristic extraction unit 120. The extraction instruction unit 121 receives the information of the device characteristic extracted by the LLM server 200 according to the extraction instruction from the LLM server 200. The extraction instruction unit 121 sends the device characteristic information received from the LLM server 200 to the characteristic extraction unit 120.

### Determination Unit 130

The determination unit 130 determines the magnitude of the device risk, which is a risk that may exist in the target device, from the device characteristics by using the information of the item risk indicating the security risk that may exist, defined for the applicability state of the security item specified by the characteristic extraction unit 120.

As described above, the device characteristic is indicated by the applicability state of the security item indicated by the information of the target device, the applicability state being specified from the information of the target device by the characteristic extraction unit 120. The applicability state of the security item is information indicating whether the information of the target device indicates the matter indicated by the security item. The applicability state of the security item indicated by the information of the target device indicates one of two states (that is, a state in which the information of the target device indicates the matter indicated by the security item, and a state in which the information of the target device does not indicate the matter indicated by the security item). A state in which the information of the target device indicates the matter indicated by the security item is referred to as an applicable state. A state in which the information of the target device does not indicate the matter indicated by the security item is referred to as a non-applicable state. Either the applicable state or the non-applicable state indicates a state that can lead to a security risk in the target device. For example, in a case where the security item indicates a matter that reduces a security risk, the non-applicable state in which the information of the target device does not indicate the matter indicated by the security item indicates a state that can lead to a security risk in the target device. For example, in a case where the security item indicates a matter that increases a security risk, the applicable state in which the information of the target device indicates the matter indicated by the security item indicates a state that can lead to a security risk in the target device. Of the applicable state and the non-applicable state indicated by the applicability state of the security item, a state that can lead to a security risk in the target device is an item risk. A risk value that is a value indicating a degree of a magnitude of the risk (in other words, the level of the risk) is associated with each item risk of the security item. The magnitude of the risk is predetermined. The above-described item risk information is, for example, information including a combination of an item risk and a risk value of the item risk, in other words, information associating the item risk of the security item with the risk value of the item list. Information indicating a risk value associated with the item risk of the security item (in other words, information that associates the security item with the risk value) is also referred to as determination reference data.

Specifically, the determination unit 130 first specifies, for each security item for which the applicability state is specified from the state of the target device, whether the applicability state of the security item is a state that can lead to a security risk in the target device.

For example, if the state of the target device is applicable to the matter indicated by the security item, the state of the target device may be a state that can lead to a security risk (for example, a state that increases a security risk). In other words, such a case is a state in which the matter indicated by the security item in the applicable state can lead to a security risk in the target device. If the state of the device is not applicable to the matter indicated by the security item, the state of the target device can be a state that may lead to a security risk. In other words, such a case is a state in which the matter indicated by the security item in the non-applicable state can lead to a security risk in the target device. For each security item, a predetermined risk value indicating the magnitude of security is associated with a state that can lead to a security risk among the applicable state and the non-applicable state. Each of the security items may be defined such that the applicable state becomes a state that can lead to a security risk. Each of the security items may be defined such that the non-applicable state becomes a state that can lead to a security risk. A security item defined such that the applicable state can be a state that can lead to a security risk and a security item defined such that the non-applicable state can be a state that can lead to a security risk may be mixed.

One or more specific risks may be associated with either the applicable state or the non-applicable state of the security item. In this case, the risk associated with either the applicable state or the non-applicable state of the security item is the item risk. A risk value may be associated with each of the item risks. For example, it is assumed that the security item indicates that “the length of the password is 8 characters or more”. In this case, the non-applicable state is a state that can lead to a security risk. In this case, the non-applicable state may be associated with risks such as “being in a fragile state in which the length of the password is less than eight characters” and “the length of the password is less than four characters, and the only characters that can be used are numbers, which is very fragile”. These risks may be associated with different risk values. For example, “5” may be associated as the risk value with the risk of “being in a fragile state in which the length of the password is less than eight characters”. For example, “10” may be associated as the risk value with the risk of “the length of the password is less than four characters, and the only characters that can be used are numbers, which is very fragile”. For example, it is assumed that the security item is “the device has a function of a database”. In this case, the applicable state is a state that can lead to a security risk. Then, for example, risks such as “information held is trade secret information, and influence of leakage is large”, “information held is personal information, and the influence of leakage is significant”, and “information held is customer information, and influence of leakage is large” may be associated with the applicable state. These risks may be associated with risk values that are not necessarily the same. In such a case, the determination unit 130 determines whether a risk is associated with a state indicated by the applicability state between the applicable state and the non-applicable state of the security item for which the applicability state is specified from the state of the target device. The determination unit 130 specifies, as an item risk, a risk associated with the state indicated by the applicability state between the applicable state and the non-applicable state of the security item for which the applicability state is specified from the state of the target device.

Either the applicable state or the non-applicable state of the security item may indicate a state that can lead to a security risk in the target device. For example, there is a case where the security item indicates that the device has a certain function, and the fact that the device has a certain function may lead to a security risk in the device. In this case, the applicable state of the security item indicates a state that can lead to a security risk in the target device. For example, the security item may indicate that the version of the software installed on the device is a predetermined version, and a state in which the version of the software is not the predetermined version may lead to a security risk in the device. In this case, the non-applicable state of the security item indicates a state that can lead to a security risk in the target device. For example, a security item may indicate that an administrator has a certain security-related credential, and a state in which the administrator does not have a certain security-related credential may lead to a security risk in the device. In this case, the non-applicable state of the security item indicates a state that can lead to a security risk in the target device. In such a case, not a specific risk but a risk value may be associated with either the applicable state or the non-applicable state of the security item. Then, out of the applicable state and the non-applicable state of the security item, a state in which the risk value is associated indicates the item risk. The determination unit 130 determines, as an item risk, a matter indicated not by a specific risk but by a state in which a risk value is associated with the security item for which the applicability state is specified from the state of the target device, out of the applicable state and the non-applicable state of the security item.

The security item may be indicated by a combination of a predetermined type of information (for example, an attribute or other type of information) of the target device and any of a plurality of conditions for a value of the predetermined type of information. This value is, for example, a numerical value, a number, a character, a character string, or the like. The condition may be that the value of the predetermined type of information is a certain value. The condition may be that the value of the predetermined type of information is included in a set of predetermined values (that is, it is the same as any value included in the set of values). The condition may be that the value of the predetermined type of information is included in a predetermined value range (for example, a numerical value range, a character range, or the like). One of the plurality of conditions may be that none of the other conditions among the plurality of conditions is satisfied. The predetermined type of information may be the number of events or the like related to the target device. The predetermined type of information may be a version of software, hardware (for example, installed software or installed hardware), or the like related to the target device. The predetermined type of information may be a name of software, hardware, or the like related to the target device. The predetermined type of information may be a name of an attribute (for example, qualification acquired by a person or organization or authentication related to security management, and the like) of a person or an organization related to the target device. The predetermined type of information and values are not limited to the above examples.

The item risk associated with the risk value or the risk value may be associated with each of the plurality of conditions described above. In this case, the risk value (for example, a risk value directly associated with the condition) associated with each of the conditions may include a risk value (hereinafter, expressed as minimum risk value) indicating that the risk is the lowest. The security item indicating that the value of the predetermined type of information satisfies the condition associated with the minimum risk value may not indicate the item risk. The security item indicating that the predetermined type of information satisfies a condition associated with a risk value that is not the minimum risk value may indicate an item risk. Then, the characteristic extraction unit 120 specifies which condition the value of the predetermined type of information indicated by the security item satisfies in the information of the target device. Then, the determination unit 130 specifies an item risk associated with a condition satisfied by the value of the predetermined type of information indicated by the security item and indicated by the information of the target device and a risk value associated with the item risk. In a case where the risk value is directly associated with the condition satisfied by the value of the predetermined type of information indicated by the security item and indicated by the information of the target device, the determination unit 130 specifies the risk value.

The security item indicated by a combination of the predetermined type of information of the target device and any of the plurality of conditions for the value of the predetermined type of information is referred to as a condition security item here. The condition security item can be regarded as a combination of security items indicating that the value of the predetermined type of information of the target device satisfies the condition for each of the plurality of conditions. For example, it is assumed that the condition security item is indicated by a combination of a certain attribute of the target device (referred to as attribute A) and a plurality of conditions (for example, condition A1, condition A2, and condition A3) for a value of the attribute. In this case, this condition security item may be considered to be a combination of three security items: “a value of attribute A satisfies condition A1”, “a value of attribute A satisfies condition A2”, and “a value of attribute A satisfies condition A3”. The risk value associated with each of the conditions of the condition security item can be regarded as the risk value associated with the applicable state of these security items.

The device risk is indicated by the specified item risk. The determination unit 130 specifies a risk value of the specified item risk. The determination unit 130 determines the statistical value of the specified risk values as the magnitude of the device risk. The statistical value is, for example, a maximum value or a sum. The statistical value is not limited to these examples. The statistical value may be an average value, a median value, an intermediate value, or the like. A specific example of the determination of the device risk from the device characteristics will be described in detail later.

### Output Unit 160

The output unit 160 outputs the magnitude of the device risk. The output unit 160 may output information indicating the specified item risk and a risk value of the item risk (that is, a value indicating the magnitude of the risk) in addition to the magnitude of the device risk. At this time, the output unit 160 may output the information indicating the specified item risk and the risk value of the item risk in the order of the magnitude of the risk. The output destination (hereinafter, referred to as an output destination of the output unit 160) to which the output unit 160 outputs the magnitude of the device risk and other information may be, for example, a display of the diagnosis support device 100. The output destination of the output unit 160 may be a terminal device of a user communicably connected to the diagnosis support device 100. The output destination of the output unit 160 may be another information processing device such as a storage device or a server that can be accessed by the diagnosis support device 100.

### Information Storage Unit 170

The information storage unit 170 stores the characteristic reference data and the determination reference data.

### Specific Example

Hereinafter, specific examples of the information of the target device, the device characteristics, and the device risk will be described in detail.

### First Specific Example

In the first specific example, the information of the target device includes information for identifying the target device. The information of the target device further includes information of a check result. The information of the target device may further include information of any of a function and an application of the target device.

The information for identifying the target device is, for example, any of a device name, an internet protocol (IP) address, a type of the target device, and other identification information.

The information of the function of the target device is information of the function of the target device. The information of the application of the target device is information regarding the application of the target device. Specifically, the information of the function of the target device is, for example, information of a function for implementing a Web server, a function of a communication interface, a storage accessible from the outside of the target device, and the like. The information of the application of the target device is, for example, information such as a Web server, connection to an external line, retention of confidential information, and retention of personal information. The function information of the target device is not limited to these examples.

The check result information is information such as a vulnerability scan result and a setting check result. The vulnerability scan is a result of a scan of the vulnerability existing in the target device performed in advance. A method of scanning for vulnerabilities existing in a target device may be one of various existing methods. The result of the setting check is a result of a check performed in advance for a predetermined type of setting item of the target device. The setting item is, for example, an item that defines a restriction, a condition, a rule, or the like for at least one of a predetermined type of operation, a predetermined type of function, or the like of the target device. For each of the predetermined types of setting items, a setting recommended as a measure against occurrence of an event related to security is predetermined. If the predetermined type of setting item of the target device is the recommended setting, the possibility that the event related to the security occurs in the target device can be reduced. The possibility that the event related to the security occurs in the target device can be further reduced as the number of setting items having the recommended setting among the predetermined type of setting items of the target device is larger. In the description of the example embodiments of the present disclosure, a setting that is not a recommended setting for the above-described predetermined type of setting item is referred to as a vulnerable setting as a setting that can lead to occurrence of an event related to security. The method for checking the setting content of the predetermined type of setting item of the target device may be one of various existing methods. The information of the target device may include, for example, information of the type of business of an association (company or other association) to which the administrator of the target device belongs.

In this specific example, the security item is an item of a guideline related to security (also referred to as a guideline item). The items of the guidelines indicate items to be adhered to and recommended matters in the state of the target device, in other words, a state to be maintained as the state of the target device. The state of the security item is indicated by whether the matter indicated by the item of the guideline is adhered to. In other words, the state of the security item is indicated by whether the state of the target device is the state indicated by the matter indicated by the item of the guideline. The device characteristics are indicated by, for example, information indicating whether items of guidelines related to security are adhered to. In the description of the example embodiments of the present disclosure, the guidelines related to security are also simply referred to as guidelines. The guidelines may include guidelines that are defined regardless of the type of business (in other words, a business field or an industry, or the like). The guideline may include a guideline defined as a standard for each type of business, a guideline defined by an association, an organization, or the like to which the administrator of the target device belongs. In a case where the information of the target device includes information of the type of business such as an association or an organization to which the administrator of the target device belongs, the characteristic extraction unit 120 may select a guideline defined in the type of business indicated by the information of the target device. The characteristic extraction unit 120 may further select a guideline determined regardless of the type of business. In a case where the information of the target device does not include information of the type of business such as an association or an organization to which the administrator of the target device belongs, the characteristic extraction unit 120 may select a guideline defined regardless of the type of business. In this specific example, the characteristic reference data includes information of the guideline. That is, the characteristic reference data is information indicating the content of the item of the guideline.

The guideline may be defined for each function of the target device. In this case, the characteristic extraction unit 120 may select a guideline defined for the function of the target device from the guidelines.

For example, the characteristic extraction unit 120 may specify the influence of at least one of the detected vulnerability and the above-described vulnerable setting in the information of the check result (that is, a vulnerability scan result, a setting check result, and the like). The influence of the vulnerability is, for example, an influence that can be caused by the vulnerability being abused. The influence of the vulnerable setting is, for example, an influence that is likely to be caused by the vulnerable setting. The influence is, for example, an event such as unauthorized access, information leakage, system failure, and network failure that can be caused by vulnerability and the above-described vulnerable setting. In the following description, the vulnerability and the vulnerable setting are collectively referred to as a vulnerable matter. In other words, the vulnerable matter is, for example, either vulnerability or vulnerable setting. The vulnerable matter may include a vulnerability, a vulnerable setting, a combination of a plurality of vulnerabilities, a combination of a plurality of vulnerable settings, and a combination of one or more vulnerabilities and one or more vulnerable settings. An event that can occur due to the vulnerable matter, in other words, an event that is assumed to increase the possibility of occurrence due to the vulnerable matter is referred to as an assumed occurrence event. A combination of a vulnerable matter and an assumed occurrence event of the vulnerable matter may be obtained in advance.

Information of an assumed occurrence event of each vulnerable matter is also referred to as vulnerability related information. The vulnerability related information is stored in advance in the information storage unit 170.

In other words, the characteristic extraction unit 120 may specify the assumed occurrence event of the information of the target device (in particular, information of vulnerable matter detected in vulnerability scan, setting check vulnerability, or the like) using, for example, the vulnerability related information.

Each of the guideline items (that is, the above-mentioned guideline items) may be associated with at least one assumed occurrence event.

In this case, the characteristic extraction unit 120 selects a guideline item related to the assumed occurrence event from the guideline items included in the selected guideline described above. For example, in a case where the assumed occurrence event is information leakage, the characteristic extraction unit 120 selects a guideline item (for example, guideline items for preventing information leakage) related to information leakage among the guideline items. For example, in a case where the assumed occurrence event is unauthorized access, the characteristic extraction unit 120 may select a guideline item related to unauthorized access (guideline item for preventing unauthorized access) among the guideline items.

The characteristic extraction unit 120 specifies a guideline item related to the vulnerable matter among the selected guideline items. The guideline item is, for example, information in which information to be protected is described. For example, the characteristic extraction unit 120 extracts a guideline item (in other words, the guideline item violated by the target device) that is not adhered to by the target device among the specified guideline items. The unadhered guideline item is an item in which the state of the target device is different from the state described in the guideline item. For example, in a case where the vulnerable matter is a vulnerability, that is, in a case where a vulnerability as a vulnerable matter is detected as a result of vulnerability scan included in the state of the target device, the guideline item related to the vulnerable matter may be a guideline item indicating that a response to the vulnerability is being made. For example, in a case where the vulnerable matter is a certain vulnerable setting, that is, in a case where the vulnerable setting is detected as the vulnerable matter as a result of the setting check included in the state of the target device, the guideline item related to the vulnerable matter may be a guideline item indicating that the vulnerable setting is not performed. Such a setting is, for example, a setting that lowers security.

The method by which the characteristic extraction unit 120 specifies the guideline item (that is, an item whose unadhered state is indicated by the state of the target device, in other words, an item not adhered to by the target device, or an item that the target device violates) related to the information of the target device may be one of any existing methods. For example, the characteristic extraction unit 120 may specify the guideline item related to the information of the target device by vector search in which the state of the target device and the guideline item are indicated by vectors. The characteristic extraction unit 120 may cause the LLM server 200 to specify a guideline item related to the information of the target device via the extraction instruction unit 121 (that is, extraction may be performed). The characteristic extraction unit 120 may regard a guideline item that has not been specified as an item not adhered to by the target device as a guideline item adhered to by the target device.

In this specific example, a risk value indicating the level of the risk (in other words, the magnitude) of each guideline item is predetermined. In this specific example, the determination reference data includes information of a predetermined risk value of each guideline item. The determination unit 130 specifies a risk value (magnitude of item risk) of a guideline item (relevant to the security item) related to the vulnerable matter. The item risk in this case is relevant to the fact that the guideline items are not adhered to. The item risk in this case may indicate an event (for example, information leakage, unauthorized access, deterioration in social credibility, and the like) predetermined as an event that may occur due to the guideline item not adhered to. The event predetermined as the event that may occur due to the guideline item not adhered to may be at least one of the above-described assumed occurrence events.

The determination unit 130 sets the statistical value of the risk value of the guideline item related to the vulnerable matter as the magnitude of the device risk.

### Second Specific Example

In the second specific example, the information of the target device includes the above-described information for identifying the target device. The information of the target device includes information indicating at least one of the type of the function of the target device and the type of the held information. The held information is information held by the target device (in other words, the information stored in the storage unit of the target device). The information of the target device may include information such as a type (for example, a server, a switch, a router, a terminal, or the like) of the target device and a product name of the target device.

The information indicating at least one of the type of the function of the target device and the type of the held information may be, for example, text information indicating one of the specification and application of the target device, a specification document indicating the specification of the target device, a manual of the target device, or the like, which is described by an administrator or the like of the target device. The specification of the target device is, for example, at least one of a name and a type of software installed in the target device. The software may be, for example, software used when the target device is used in an application of the target device. The application of the target device is, for example, information indicating how the target device is used, such as a communication network to which the target device is connected (for example, whether the target device is connected to an external network), management of customer information, management of employee information, management of sales information, and transmission of information to the outside of the company. The external network is, for example, a communication network that is not a communication network managed by an entity that manages the target device. The text information indicating any one of the specification and the application of the target device is, for example, sentences or character strings describing the specification of the target device. The specification document is, for example, a document describing any one of the specification of the target device and the use of the target device. The manual of the target device is, for example, a document describing at least one of a specification of the target device, an application of the target device, an operation on the target device when managing the target device, an operation on the target device when using the target device in the application of the target device, and the like.

In this specific example, the security item is an item (hereinafter, also referred to as a device item) indicating a matter defined for at least one of the type of the function and the type of the held information. The characteristic reference data includes information of a predetermined device item. The type of function is, for example, an external network connection which is a type of function indicating that it is connected to an external network, a database which is a type of function indicating that it functions as a database, a terminal which is a type of function indicating that an employee is using the terminal, or the like. The type of function is not limited to these examples. The type of function may not include these examples. The type of the held information is, for example, confidential information, personal information, public information, or the like. The confidential information is, for example, information that is confidential to an entity other than the entity that manages the target device. The personal information is, for example, information requiring special handling as information indicating an individual by law or the like. The public information is, for example, public information (in other words, information that is also disclosed to a person other than the entity that manages the target device). The type of the held information is not limited to these examples. The type of the held information may not include these examples.

The characteristic extraction unit 120 extracts the device characteristic (in other words, information indicating device characteristics) from the information of the device by specifying the device item indicating the information indicating at least one of the type of the function of the target device and the type of the held information included in the information of the target device among the predetermined device items. In this case, the device characteristic is indicated by a device item indicating information indicating at least one of the type of the function of the target device and the type of the held information among predetermined device items.

The characteristic extraction unit 120 may estimate the function of the target device from the type, the product name, and the like of the target device using the characteristic reference data. In this case, the characteristic reference data includes information associated with the type, product name, and the like of the target device and the device item indicating the type of function of the target device.

For example, in a case where a keyword predetermined for each type of function is included in the information of the target device, the characteristic extraction unit 120 may determine that the function of the target device includes the function indicated by the type of function related to the keyword, using the characteristic reference data. For example, in a case where a keyword predetermined for each type of the held information is included in the information of the target device, the characteristic extraction unit 120 may determine that the held information of the target device includes the held information indicated by the type of the held information related to the keyword. In this case, the characteristic reference data includes the keyword and the information associated with the device item indicating one of the type of the function and the type of the held information. The characteristic extraction unit 120 may cause the LLM server 200 to estimate at least one of the type of the function of the target device and the type of the held information from the information of the target device via the extraction instruction unit 121. In other words, the characteristic extraction unit 120 may transmit, to the LLM server 200 via the extraction instruction unit 121, the information of the target device and an instruction to estimate at least one of the type of the function of the target device and the type of the held information from the information of the target device. Then, the characteristic extraction unit 120 may receive at least one of the type of the function of the target device and the type of the held information estimated by the LLM server 200 from the LLM server 200 via the extraction instruction unit 121.

In a case where at least one of the device item indicating the type of the function and the device item indicating the type of the held information cannot be specified from the information of the target device, the characteristic extraction unit 120 may not extract at least one of the device item indicating the type of the function and the device item indicating the type of the held information that cannot be specified. For example, in a case where it is not specified from the information of the target device that the information indicated by any one of the device items indicating the type of the held information is stored in the target device, the characteristic extraction unit 120 may not extract the device item indicating the type of the held information. In a case where it is not specified that the target device has the function indicated by any of the device items indicating the type of function, the characteristic extraction unit 120 may not extract the device item indicating the type of function.

The characteristic extraction unit 120 may extract a plurality of device items indicating different types of functions for one target device. The characteristic extraction unit 120 may extract a plurality of device items indicating different types of held information for one target device.

For example, in the above-described example, in a case where the information of the target device indicates that the target device is a Web server connected to an external network for public relations to the outside of the organization, the characteristic extraction unit 120 extracts, for example, a device item indicating “external network connection” as the type of function. In this case, the characteristic extraction unit 120 further extracts an item indicating “public information” as the type of the held information. For example, in a case where the target device is a device that functions as a database not connected to an external network, the characteristic extraction unit 120 extracts a device item indicating “database” as the type of function. In this case, the characteristic extraction unit 120 further extracts an item indicating the type of information stored in the database as the type of the held information. For example, in a case where the target device is a terminal device that is used by an employee, is not connected to an external network, and does not hold information, the characteristic extraction unit 120 extracts a device item indicating “terminal” as the type of function, for example. In this case, the characteristic extraction unit 120 may not extract the device item indicating the type of the held information.

In each of the device items, a risk value that is a value indicating the magnitude of the risk is predetermined. In this specific example, the determination reference data includes information of a risk value predetermined for each of the device items.

The determination unit 130 specifies a risk value (that is, the magnitude of the item risk) of the device item extracted as the information indicating the device characteristic. The item risk in this case is relevant to having the function of the type indicated by the device item and holding the held information of the type indicated by the device item. The risk value of the device item indicating the type of function may be, for example, a value that is appropriately determined according to the degree of possibility that the target device will be attacked, the degree of damage in a case where the target device will be attacked, and the like by the target device having the function (for example, by being connected to an external network or the like). The risk value of the device item indicating the type of the held information may be, for example, a value that is appropriately determined according to the degree of damage to the entity that manages the device, the influence on society, and the like due to leakage of the held information.

The determination unit 130 sets the statistical value of the risk value of the device item extracted as the information indicating the device characteristic as the magnitude of the device risk.

### Third Specific Example

In the third specific example, the information of the target device includes information of a management entity of the target device. The management entity is, for example, either a person who manages the target device or an organization (for example, a company, a government agency, a local government, another association, an internal organization of the organization, and the like) that manages the target device. The internal organization of the organization is, for example, a department that is a group created in the organization, such as a business division, a department, or a section.

In a case where the management entity is a person, the information of the management entity is information specifying the person, information of an incident that has occurred in the past in the device managed by the person, a qualification acquired by the person, a nationality, and the like. The incident is, for example, an event related to security, such as intrusion from an external network or information leakage.

In a case where the management entity is an organization, the information of the management entity includes a type of business or the like of the management entity (for example, a business field, an industry, or the like), authentication information regarding security management acquired by the management entity, information of incidents that have occurred in the past in a device managed by the organization, and the like.

The information of the incident may include information of the date and time when the incident occurred.

In this specific example, the security item includes a management entity item indicating a matter defined for the information of the management entity.

The management entity item may include, for example, items indicating matters indicating each of a matter indicating a type of authentication regarding security management received by the management entity and a matter indicating that the management entity has not received authentication regarding security management. The authentication type is, for example, one or more predetermined authentication types. Different types of authentication may be indicated by different management entity items.

The management entity item may include, for example, items indicating matters indicating each of a matter indicating the type of qualification that the management entity has acquired and a matter indicating that the management entity has not acquired the qualification. Different types of qualifications may be indicated by different management entity items.

The management entity item may include, for example, a matter indicating each of the types of the business of the management entity, which is predetermined as the type of the business of the management entity. Different types of business may be indicated by different management entity items.

The management entity item may include, for example, an item indicating a matter indicating the nationality of the management entity. Different nationalities may be indicated by different management entity items.

The management entity item may be indicated by a matter indicating the presence or absence of an incident that has occurred within the latest predetermined period in a device, a system, or the like managed by the management entity. A plurality of different predetermined periods may be defined. In this case, the management entity item may include items indicating matters indicating each of a matter indicating that an incident has occurred within the latest predetermined period and a matter indicating that no incident has occurred in a device, a system, or the like managed by the management entity.

In this specific example, the characteristic reference data includes information indicating the management entity item.

The characteristic extraction unit 120 may extract the device characteristic from the information of the target device by specifying the established management entity item in the information of the target device (specifically, information of the management entity of the target device included in the information of the target device) from the predetermined management entity item. In this case, the device characteristic is indicated by the established management entity item in the information of the target device (specifically, information of the management entity of the target device included in the information of the target device) among the predetermined management entity items. In this specific example, the item risk is indicated by the management entity item established in the information of the target device.

The characteristic reference data may include information of an incident that has occurred in a device managed by the management entity, information of authentication related to security management, information of the type of business, and the like for each management entity that is an association or an organization. In this case, the information of the target device may not include the information of the incident that has occurred, the information of the authentication related to the security management, the information of the type of the business, and the like. The characteristic extraction unit 120 specifies, from the characteristic reference data, information of an incident that has occurred, authentication information of security management, information of the type of business, and the like of the management entity indicated by the information specifying the management entity (for example, information specifying an organization that is a management entity) included in the information of the target device (in particular, information of the management entity of the target device).

The characteristic extraction unit 120 may cause the LLM server 200 to estimate, from the information of the target device, at least one of information of an incident that has occurred in a device managed by the management entity, information of authentication related to security management, information of the type of business, and the like via the extraction instruction unit 121. In other words, the characteristic extraction unit 120 may transmit, to the LLM server 200 via the extraction instruction unit 121, the information of the target device and an instruction to estimate, from the information of the target device, at least one of the information of the incident that has occurred in the device managed by the management entity, the information of the authentication related to the security management, the information of the type of the business, and the like. Then, the characteristic extraction unit 120 may receive, from the LLM server 200 via the extraction instruction unit 121, at least one of information of an incident that has occurred in a device managed by the management entity, information of authentication related to security management, information of the type of business, and the like, estimated by the LLM server 200.

The characteristic reference data may include, for each management entity that is a person, information of an incident that has occurred in a device managed by the management entity, qualification information, nationality information, and the like. In this case, the information of the target device may not include the information of the incident, the qualification information, the nationality information, and the like that have occurred in the device managed by the management entity. The characteristic extraction unit 120 specifies, from the characteristic reference data, information of the incident that has occurred, qualification information, nationality information, and the like of the management entity indicated by the information specifying the management entity (for example, information for specifying a person who is a management entity) and is included in the information of the target device (particularly, the information of the management entity of the target device).

The characteristic extraction unit 120 may cause the LLM server 200 to estimate, from the information of the target device, at least one of information of an incident that has occurred in a device managed by the management entity, qualification information, nationality information, and the like via the extraction instruction unit 121. In other words, the characteristic extraction unit 120 may transmit, to the LLM server 200 via the extraction instruction unit 121, the information of the target device and an instruction to estimate, from the information of the target device, at least one of the information of the incident that has occurred in the device managed by the management entity, the qualification information, the nationality information, and the like. Then, the characteristic extraction unit 120 may receive, from the LLM server 200 via the extraction instruction unit 121, at least one of information of an incident that has occurred in a device managed by the management entity, qualification information, nationality information, and the like, estimated by the LLM server 200.

In this specific example, the determination reference data includes information of a risk value associated with the management entity item.

In a case where the management entity item is a matter indicating the presence or absence of an incident that has occurred within the latest predetermined period in the device managed by the management entity, the risk value of the management entity item may be determined such that the magnitude of the risk indicated by the risk value increases as the predetermined period in which the incident has occurred becomes more recent. The risk value of the management entity item indicating that no incident has occurred is determined such that the magnitude of the risk is smaller than the risk value of the management entity item indicating that the incident has occurred.

In a case where the management entity item indicates authentication related to security management received by the management entity, a risk value indicating that the risk is smaller as the credibility of the authentication indicated by the management entity item is higher may be defined. In this case, the risk value of the management entity item indicating that the authentication has not been received is set such that the magnitude of the risk is larger than the risk value of the management entity item indicating that the authentication has been received.

In a case where the management entity item indicates the type of business of the management entity (that is, the industry), the risk value of the management entity item may be defined such that the magnitude of the risk indicated by the risk value increases as strictness of rules such as laws and regulations applied to the industry and rules regarding security in the industry becomes stricter. For example, in an industry in which an incident has a large influence on a management entity that manages a device in which the incident has occurred, rules such as laws and regulations applied to the industry and rules regarding security in the industry may be more strictly defined. In such a case, the risk value of the management entity item may be defined as described above. It is considered that the strictness of rules such as laws and regulations applied to the industry and rules regarding security in the industry increases the possibility that the rules are adhered to. The risk value of the management entity item may be determined such that the magnitude of the risk indicated by the risk value becomes smaller as strictness of rules such as laws and regulations applied to the industry and rules regarding security in the industry becomes stricter without considering the magnitude of the influence in a case where an incident occurs. The risk value of the management entity item may be appropriately determined by the administrator from strictness of rules such as laws and regulations applied to the industry and rules regarding security in the industry and a tendency of a magnitude of a general influence in a case where an incident occurs in the industry. The determination of the degree of severity may be performed according to a rule appropriately determined.

In a case where the management entity item indicates the qualification regarding security acquired by the management entity, a risk value indicating that the risk is smaller as the credibility of the qualification indicated by the management entity item is higher may be defined. In this case, the risk value of the management entity item indicating that the qualification is not acquired is set such that the magnitude of the risk is larger than the risk value of the management entity item indicating that the qualification is acquired.

In a case where the management entity item indicates the nationality of the management entity who is a person, the risk value of the management entity item may be set such that the magnitude of the risk increases as the strength of the authority of the command to the people of the country by the country is stronger, which is defined by the law of the country indicated by the nationality. The strength of the authority of the command may be appropriately determined according to the presence or absence of a law by which the country instructs the behavior of the people, the severity of the penalty in a case where the people do not follow the instruction of the country, and the like. In a case where the management entity item indicates the nationality of the management entity who is a person, the risk value of the management entity item may be set such that the magnitude of the risk increases as the number of occurrences of incidents related to security in the device managed by the management entity per unit period increases for each nationality of the management entity.

The determination unit 130 sets the statistical value of the risk value of the management entity item extracted as the information indicating the device characteristic as the magnitude of the device risk.

### Fourth Specific Example

Any two or more of the first specific example to the third specific example may be combined. In this case, the determination unit 130 sets the statistical value of the risk value of the security item extracted as the information indicating the device characteristic as the magnitude of the device risk.

In the above description, the security item indicates a matter related to security. However, the security item may be indicated by a type of the target device and a value of information of the target device or a management entity of the target device relevant to the type.

### Operation

Next, an operation of the diagnosis support device 100 according to the second example embodiment of the present disclosure will be described in detail with reference to the drawings.

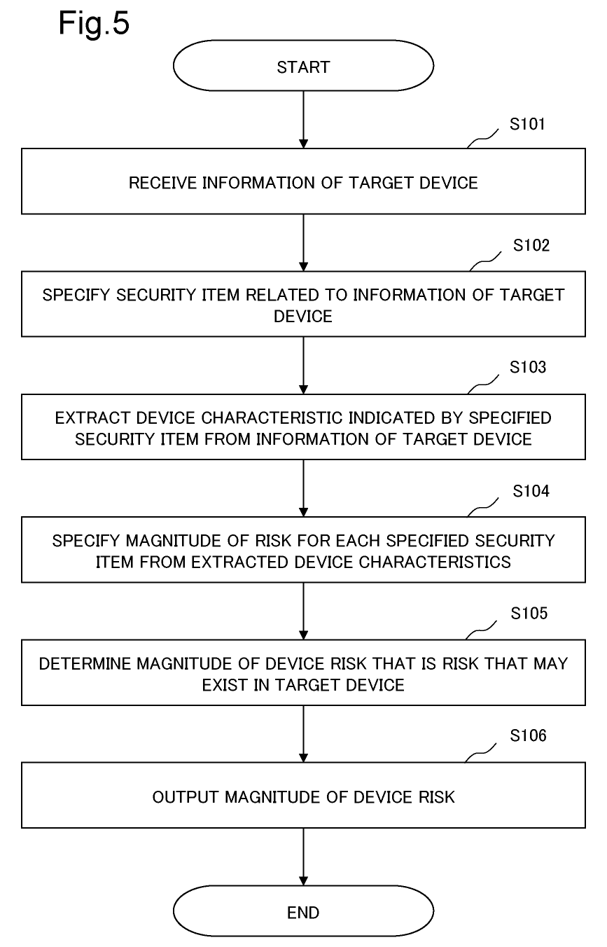

FIG. 5 is a flowchart illustrating an example of the operation of the diagnosis support device according to the present disclosure.

Hereinafter, an example of the operation of the diagnosis support device 100 according to the second example embodiment of the present disclosure will be described in detail using FIG. 5.

In the example illustrated in FIG. 5, first, the instruction receiving unit 110 receives information of the target device, for example, as a determination instruction that is an instruction to make a determination related to the target device (step S101).

Next, the characteristic extraction unit 120 specifies a security item related to the information of the target device (step S102). For example, in a case where the information of the target device includes at least one of the result of a scan of vulnerability and the result of setting check, the characteristic extraction unit 120 specifies the item of the guideline as the security item. The characteristic extraction unit 120 may select a guideline to be used from a plurality of predetermined guidelines as described above. Then, the item of the selected guideline may be specified as the security item. In a case where the information of the target device includes information indicating at least one of the type of the function of the target device and the type of the held information of the target device, the characteristic extraction unit 120 specifies the above-described device item as the security item. In a case where the information of the target device includes the information of the management entity of the target device, the characteristic extraction unit 120 selects the management entity item as the security item. The security item related to the information of the target device may be determined in advance. In other words, the security item related to the information of the target device may be specified in advance. In that case, the characteristic extraction unit 120 does not need to perform the operation of step S102. The characteristic extraction unit 120 extracts the device characteristic indicated by the specified security item from the information of the target device (step S103).

In step S103, as described above, the characteristic extraction unit 120 may send an execution instruction for causing the LLM server 200 to execute processing of extracting at least a part of the device characteristics from at least a part of the information of the target device to the extraction instruction unit 121. In this case, the characteristic extraction unit 120 receives the information of the device characteristic from the extraction instruction unit 121 that has received the information of the device characteristic extracted by the LLM server 200. In other words, the characteristic extraction unit 120 receives the information of the device characteristic extracted by the LLM server 200 from the LLM server 200 via the extraction instruction unit 121.

The determination unit 130 specifies the magnitude of the risk for each specified security item from the extracted device characteristics (step S104). The determination unit 130 determines a magnitude of a device risk that is a risk that may exist in the target device (step S105).

The output unit 160 outputs the magnitude of the device risk (step S106). In step S106, as described above, the output unit 160 may output the information indicating the specified item risk and the risk value of the item risk (that is, the value indicating the magnitude of the risk), in addition to the magnitude of the device risk. At this time, the output unit 160 may output the information indicating the specified item risk and the risk value of the item risk in the order of the magnitude of the risk.

### Effects

The present example embodiment described above has the same effect as the first example embodiment. The effect is achieved by the reason same as the reason why the effect of the first example embodiment is achieved.

### Third Example Embodiment

Next, a third example embodiment of the present disclosure will be described in detail with reference to the drawings.

### Configuration

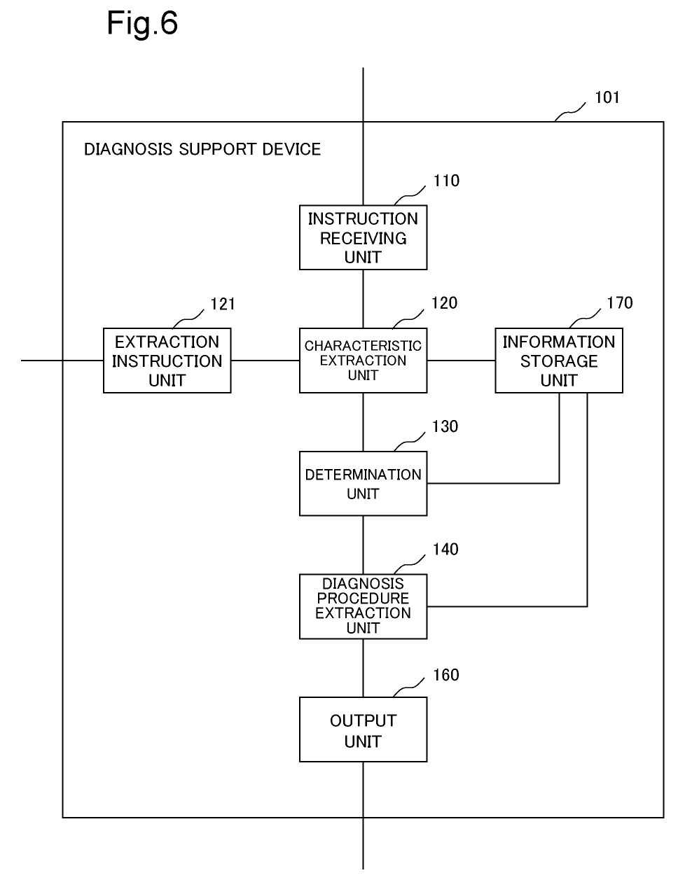

FIG. 6 is a block diagram illustrating a configuration of a diagnosis support device according to the present disclosure.

A configuration of the diagnosis support device according to the third example embodiment of the present disclosure will be described in detail with reference to FIG. 6.

### Diagnosis Support Device 101

In the example illustrated in FIG. 6, the diagnosis support device 101 includes an instruction receiving unit 110, a characteristic extraction unit 120, an extraction instruction unit 121, a determination unit 130, a diagnosis procedure extraction unit 140, an output unit 160, and an information storage unit 170.

The instruction receiving unit 110, the characteristic extraction unit 120, the extraction instruction unit 121, the determination unit 130, the output unit 160, and the information storage unit 170 of the present example embodiment have the same functions as the instruction receiving unit 110, the characteristic extraction unit 120, the extraction instruction unit 121, the determination unit 130, the output unit 160, and the information storage unit 170 of the second example embodiment. The instruction receiving unit 110, the characteristic extraction unit 120, the extraction instruction unit 121, the determination unit 130, the output unit 160, and the information storage unit 170 of the present example embodiment perform operations similar to the operations of the instruction receiving unit 110, the characteristic extraction unit 120, the extraction instruction unit 121, the determination unit 130, the output unit 160, and the information storage unit 170 of the second example embodiment. The diagnosis support device 101 of the present example embodiment is the same as the diagnosis support device 100 of the second example embodiment except for differences described below.

The diagnosis support system according to the present example embodiment is a system in which the diagnosis support device 100 is replaced by the diagnosis support device 101 in the example illustrated in FIG. 3.

### Information Storage Unit 170

The information storage unit 170 further stores information of a diagnosis procedure associated with a combination of the type of the device to be diagnosed and the security item extracted as the device characteristic. The diagnosis procedure is a procedure for diagnosing whether the target device is in a state in which a risk actually exists (in other words, whether a risk actually exists in the target device) in a case where the state of the target device is the state indicated by the security item extracted as the device characteristic. The diagnosis procedure may be a procedure predetermined as a procedure for diagnosing the presence or absence of a risk specified as a risk that may exist in the target device in a case where the state of the target device is the state indicated by the security item extracted as the device characteristic.

### Diagnosis Procedure Extraction Unit 140

The diagnosis procedure extraction unit 140 extracts a diagnosis procedure for diagnosing an actual state of a risk in the target device. The diagnosis of the actual state of the risk in the target device is, for example, a diagnosis for specifying whether the risk actually exists in the target device. The diagnosis of the actual state of the risk in the target device may be, for example, a diagnosis of whether the target device is in a state where the risk can actually occur based on settings in the OS, software, hardware, and the like of the target device, various conditions in the environment of the system including the target device, and the like. The diagnosis procedure extraction unit 140 extracts the information of the diagnosis procedure associated with the combination of the type of the target device and the security item extracted as the device characteristic from the information of the diagnosis procedure stored in the information storage unit 170.

### Output Unit 160

The output unit 160 further outputs information of the extracted diagnosis procedure. When the information of the diagnosis procedure is output, the output unit 160 may output a combination of the magnitude of the risk for each specified security item (in other words, the item risk) and the diagnosis procedure associated with the security item in the descending order of the risk of the security item, for example. In this case, the output unit 160 may output the risk value described above as the magnitude of the risk. The output destination (hereinafter, referred to as an output destination of the output unit 160) to which the output unit 160 outputs the magnitude of the device risk and other information (for example, information of the diagnosis procedure) may be, for example, a display of the diagnosis support device 101. The output destination of the output unit 160 may be a terminal device of a user communicably connected to the diagnosis support device 101. The output destination of the output unit 160 may be another information processing device such as a storage device or a server that can be accessed by the diagnosis support device 101.

### Operation

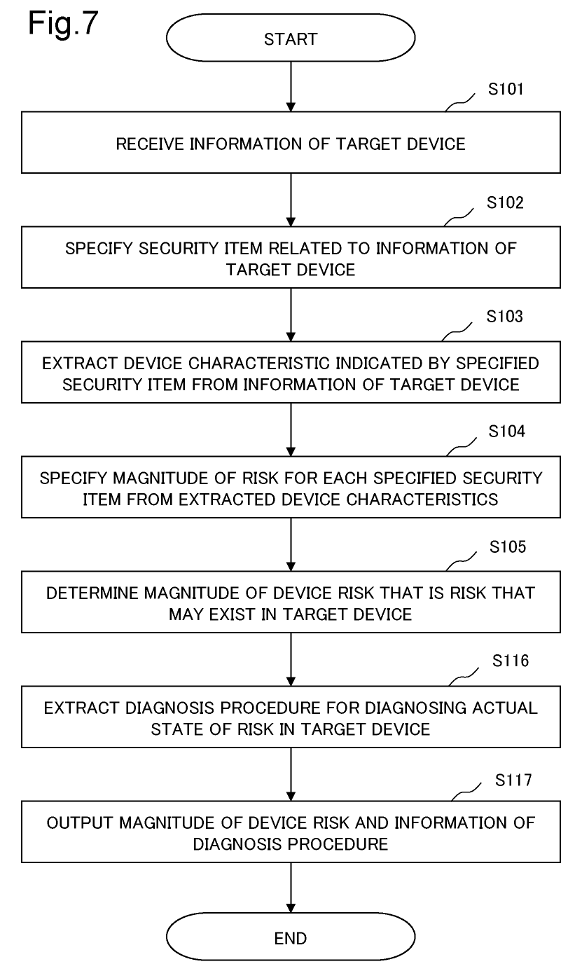

FIG. 7 is a flowchart illustrating an example of the operation of the diagnosis support device according to the present disclosure.

Hereinafter, an example of the operation of the diagnosis support device 101 according to the third example embodiment of the present disclosure will be described in detail using FIG. 7.

In the example illustrated in FIG. 7, the operations from step S101 to step S105 are the same as the operations from step S101 to step S105 in the example illustrated in FIG. 5.

After step S105, the diagnosis procedure extraction unit 140 extracts a diagnosis procedure for diagnosing whether a risk actually exists in the target device (step S116).

Next, the output unit 160 outputs the magnitude of the device risk and the information of the diagnosis procedure (step S117).

### Effects

The present example embodiment described above has the same effect as the first example embodiment. The effect is achieved by the reason same as the reason why the effect of the first example embodiment is achieved. The present example embodiment has an effect that it is possible to grasp at an early stage by early diagnosis whether a risk actually exists in a monitoring target or the monitoring target is in a state where the risk can actually occur, and to take measures as necessary. This is because, in the present example embodiment, the output unit 160 outputs the diagnosis procedure associated with the specified security item. Furthermore, the present example embodiment also has an effect that the above can be grasped from a security item having a high risk among the specified security items, and a measure can be taken. This is because the output unit 160 outputs a combination of the magnitude of the risk of the specified security item and the diagnosis procedure. This enables diagnosis according to a diagnosis procedure from a security item having a high risk. When it is confirmed by diagnosis that a risk actually exists, a measure against the risk becomes possible.

### Fourth Example Embodiment

Next, a fourth example embodiment of the present disclosure will be described in detail with reference to the drawings.

### Configuration

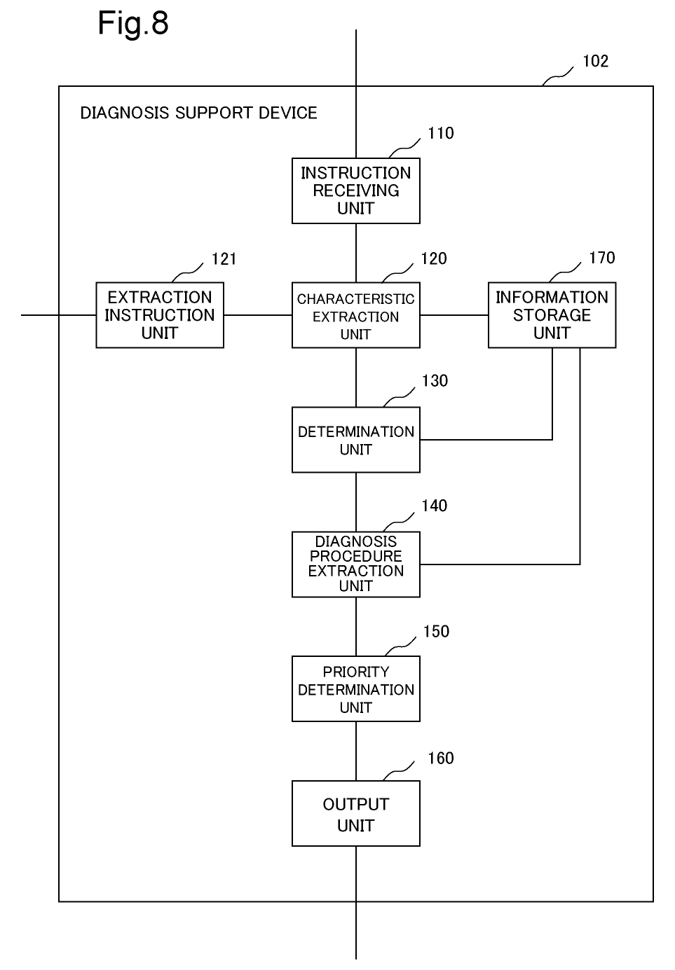

FIG. 8 is a block diagram illustrating a configuration of a diagnosis support device according to the present disclosure.

A configuration of the diagnosis support device according to the fourth example embodiment of the present disclosure will be described in detail with reference to FIG. 8.

### Diagnosis Support Device 102

In the example illustrated in FIG. 8, the diagnosis support device 102 includes an instruction receiving unit 110, a characteristic extraction unit 120, an extraction instruction unit 121, a determination unit 130, a diagnosis procedure extraction unit 140, a priority determination unit 150, an output unit 160, and an information storage unit 170.

The instruction receiving unit 110, the characteristic extraction unit 120, the extraction instruction unit 121, the determination unit 130, the diagnosis procedure extraction unit 140, the output unit 160, and the information storage unit 170 of the present example embodiment have the same functions as the instruction receiving unit 110, the characteristic extraction unit 120, the extraction instruction unit 121, the determination unit 130, the diagnosis procedure extraction unit 140, the output unit 160, and the information storage unit 170 of the third example embodiment. The instruction receiving unit 110, the characteristic extraction unit 120, the extraction instruction unit 121, the determination unit 130, the diagnosis procedure extraction unit 140, the output unit 160, and the information storage unit 170 of the present example embodiment perform operations similar to the operations of the instruction receiving unit 110, the characteristic extraction unit 120, the extraction instruction unit 121, the determination unit 130, the diagnosis procedure extraction unit 140, the output unit 160, and the information storage unit 170 of the third example embodiment. The diagnosis support device 102 of the present example embodiment is the same as the diagnosis support device 101 of the third example embodiment except for differences described below.

The diagnosis support system according to the present example embodiment is a system in which the diagnosis support device 100 is replaced by the diagnosis support device 102 in the example illustrated in FIG. 3.

### Instruction Receiving Unit 110

The instruction receiving unit 110 receives a determination instruction that is an instruction to make a determination related to a plurality of target devices.

### Characteristic Extraction Unit 120

The characteristic extraction unit 120 extracts the device characteristic indicating the information related to the security of each of the plurality of target devices from the information of the plurality of target devices.

### Determination Unit 130

The determination unit 130 determines a magnitude of a device risk, which is a risk that may exist in each of the plurality of target devices, from the device characteristics of the plurality of target devices.

### Diagnosis Procedure Extraction Unit 140

The diagnosis procedure extraction unit 140 extracts a diagnosis procedure for diagnosing whether a risk actually exists in a plurality of target devices for each target device.

### Priority Determination Unit 150

The priority determination unit 150 uses the magnitudes of the device risks of the plurality of target devices to determine the priority of diagnosis of the plurality of diagnosis devices. The priority determination unit 150 determines the priority such that the higher the magnitude of the device risk of the target device, the higher the priority of diagnosis of the diagnosis device.

### Output Unit 160

The output unit 160 outputs the magnitudes of the device risks of the plurality of target devices and the information of the diagnosis procedure in order of the determined priority. At that time, the output unit 160 may output a combination of the magnitude of the risk for each specified security item (in other words, the item risk) and the diagnosis procedure associated with the security item for each target device, for example, in descending order of the risk of the security item. In this case, the output unit 160 may output the above-described risk value as the magnitude of the risk of the security item. The output destination (hereinafter, referred to as an output destination of the output unit 160) to which the output unit 160 outputs the magnitude of the device risk, the information of the diagnosis procedure, and the like of the plurality of target devices may be, for example, a display of the diagnosis support device 102. The output destination of the output unit 160 may be a terminal device of a user communicably connected to the diagnosis support device 102. The output destination of the output unit 160 may be another information processing device such as a storage device or a server that can be accessed by the diagnosis support device 102.

### Operation

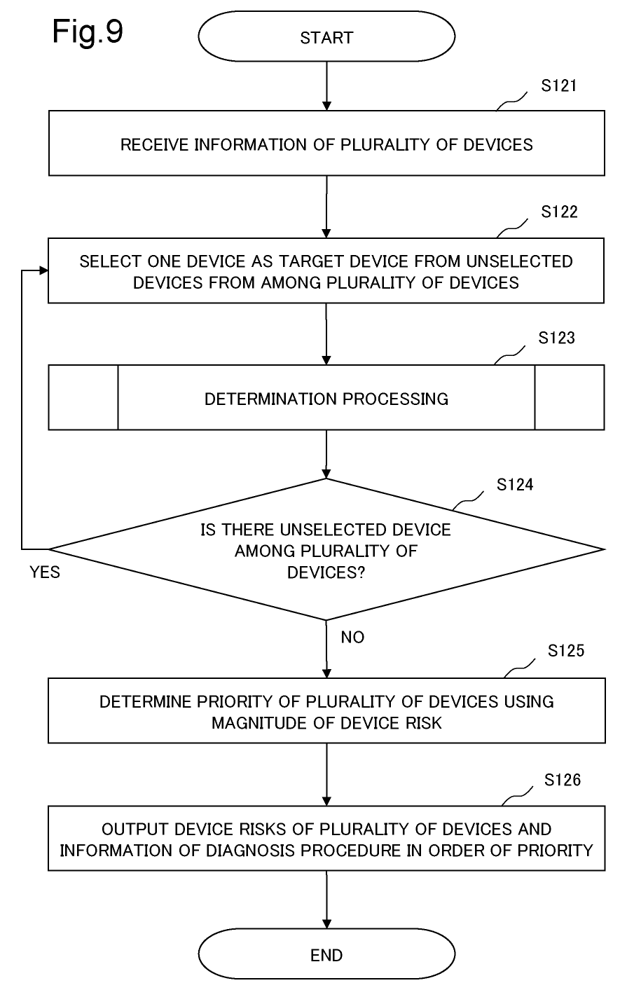

FIG. 9 is a flowchart illustrating an example of the entire operation of the diagnosis support device according to the present disclosure.

Hereinafter, an overall example of the operation of the diagnosis support device 102 according to the fourth example embodiment of the present disclosure will be described in detail using FIG. 9.

In the example illustrated in FIG. 9, the instruction receiving unit 110 receives information of a plurality of devices to be target devices (step S121).

Next, for example, the characteristic extraction unit 120 selects one device as the target device from among the plurality of devices that have not been selected (step S122).

Next, the diagnosis support device 102 performs determination processing (step S123). The determination processing will be described in detail later.

In a case where there is an unselected device among the plurality of devices (YES in step S124), the diagnosis support device 102 repeats the operations in and after step S122.

In a case where there is no unselected device among the plurality of devices (NO in step S124), that is, in a case where all of the plurality of devices are selected as the target devices, the priority determination unit 150 determines the priorities of the plurality of devices using the magnitude of the device risk (step S125).

Then, the output unit 160 outputs the device risks of the plurality of devices and the information of the diagnosis procedure in order of priority (step S126).

Next, an operation of determination processing of the diagnosis support device 102 according to the fourth example embodiment of the present disclosure will be described in detail with reference to the drawings.

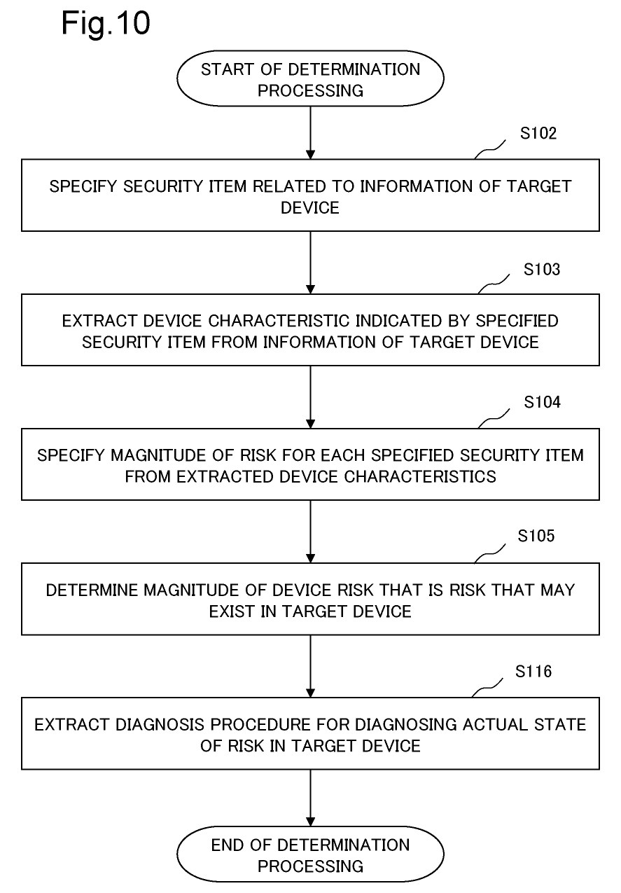

FIG. 10 is a flowchart illustrating an example of an operation of determination processing of the diagnosis support device according to the present disclosure.

Hereinafter, an example of the operation of the determination processing of the diagnosis support device 102 according to the fourth example embodiment of the present disclosure will be described in detail using FIG. 10. The operations in steps S102 to S105 and S116 illustrated in FIG. 10 are the same as the operations in steps S102 to S105 and S116 illustrated in FIG. 7.

### Effects

The present example embodiment described above has the same effect as the third example embodiment. The effect is achieved by the reason same as the reason why the effect of the third example embodiment is achieved. The present example embodiment has an effect that diagnosis can be started from a device that is better to perform diagnosis early among a plurality of devices. This is because the priority determination unit 150 determines the priority from the magnitude of the device risk of the plurality of devices. This is because the output unit 160 outputs the device risks of the plurality of devices and the information of the diagnosis procedure in the order of the determined priority.

### Other Example Embodiments

The diagnosis support device according to the example embodiments of the present disclosure can be implemented by a computer and a program for controlling the computer, dedicated hardware, or a combination of the computer and the program for controlling the computer and the dedicated hardware.

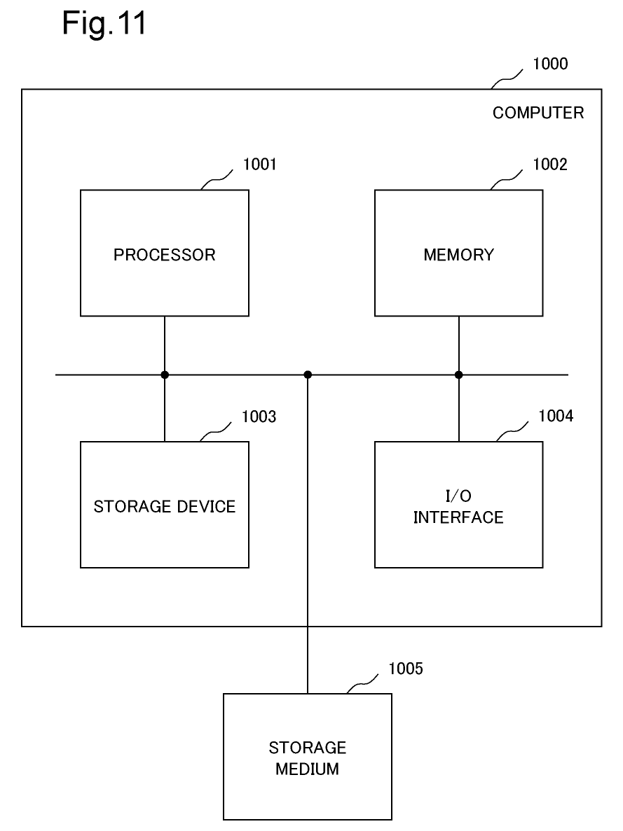

FIG. 11 is a diagram illustrating an example of a hardware configuration of a computer 1000 that can implement the diagnosis support device according to the example embodiments of the present disclosure. FIG. 11 illustrates the example in which the computer 1000 includes a processor 1001, a memory 1002, a storage device 1003, and an input/output (I/O) interface 1004. The computer 1000 can access a storage medium 1005. The memory 1002 and the storage device 1003 are storage devices such as a random access memory (RAM) and a hard disk, for example. Examples of the storage medium 1005 include a RAM, a storage device such as a hard disk, a read only memory (ROM), and a portable storage medium. The storage device 1003 may be the storage medium 1005. The processor 1001 can read and write data and programs from and to the memory 1002 and the storage device 1003. The processor 1001 can access the LLM server 200 using the I/O interface 1004, for example. The processor 1001 can access the storage medium 1005. The storage medium 1005 stores a program for operating the computer 1000 as the diagnosis support device according to the example embodiments of the present disclosure.

The processor 1001 loads a program, which is stored in the storage medium 1005 and causes the computer 1000 to operate as the diagnosis support device according to the example embodiments of the present disclosure, into the memory 1002. Then, when the processor 1001 executes the program loaded in the memory 1002, the computer 1000 operates as the diagnosis support device according to the example embodiments of the present disclosure.

The instruction receiving unit 110, the characteristic extraction unit 120, the extraction instruction unit 121, the determination unit 130, the diagnosis procedure extraction unit 140, the priority determination unit 150, and the output unit 160 can be implemented by, for example, the processor 1001 that executes a program loaded in the memory 1002. The information storage unit 170 can be implemented by the memory 1002 included in the computer 1000 or the storage device 1003 such as a hard disk. Part or all of the instruction receiving unit 110, the characteristic extraction unit 120, the extraction instruction unit 121, the determination unit 130, the diagnosis procedure extraction unit 140, the priority determination unit 150, the output unit 160, and the information storage unit 170 can be implemented by a dedicated circuit that implements each function.

Some or all of the above example embodiments may be described as the following Supplementary Notes, but are not limited to the following.

### (Supplementary Note 1)

A diagnosis support device including:

a characteristic extraction means for extracting a device characteristic indicating information related to security of a target device from information of the target device;

a determination means for determining, from the device characteristic, a magnitude of a device risk that is a risk that may exist in the target device, based on a magnitude of a risk for each security item that is a predetermined item related to security; and

an output means for outputting a magnitude of the device risk.

### (Supplementary Note 2)

The diagnosis support device according to Supplementary Note 1, further including

a procedure extraction means for extracting a diagnosis procedure for diagnosing an actual state of a risk in the target device, wherein

the output means outputs information of the diagnosis procedure extracted.

### (Supplementary Note 3)

The diagnosis support device according to Supplementary Note 2, wherein

the characteristic extraction means extracts the device characteristic from information of each of a plurality of target devices,

the determination means determines the device risk of each of the plurality of target devices, and

the output means outputs the magnitude of the device risk of the plurality of target devices and the information of the diagnosis procedure in order of the magnitude of the device risk.

### (Supplementary Note 4)

The diagnosis support device according to any one of Supplementary Notes 1 to 3, wherein

the characteristic extraction means extracts the device characteristic indicated by the security item indicating a matter related to security from the information of the target device, and

the determination means determines the device risk from the device characteristic by using information of an item risk indicating a security risk that may exist, the security risk being defined for a state of the security item.

### (Supplementary Note 5)

The diagnosis support device according to Supplementary Note 4, wherein

the determination means determines a statistical value of a magnitude of the item risk of the security item specified, as the magnitude of the device risk.

### (Supplementary Note 6)

The diagnosis support device according to Supplementary Note 4, wherein

the information of the target device includes information indicating at least one of a result of a scan of vulnerability of the target device and a result of checking a setting of the target device,

the security item includes a guideline item indicating a matter to be adhered to, the matter being defined in a security guideline, and

the characteristic extraction means extracts, as the device characteristic, information indicating the guideline item that is not adhered to in the target device among guideline items by using the information of the target device.

### (Supplementary Note 7)

The diagnosis support device according to Supplementary Note 6, wherein

the characteristic extraction means specifies an influence of at least one of the vulnerability indicating that the result of the scan exists and the setting indicated by the result of the checking, and sets the guideline item related to the influence as the guideline item that is not adhered to.

### (Supplementary Note 8)

The diagnosis support device according to Supplementary Note 4, wherein

the information of the target device includes information indicating at least one of a type of a function of the target device and a type of held information that is information to be held,

the security item includes a device item indicating a matter defined for at least one of the type of the function and the type of the held information, and

the characteristic extraction means extracts information indicating the device item indicating at least one of the type of the function of the target device and the type of the held information among the device item as the device characteristic by using the information of the target device.

### (Supplementary Note 9)

The diagnosis support device according to Supplementary Note 8, wherein

the information of the target device includes information indicating at least one of a specification and an application of the target device as the information indicating at least one of the type of the function of the target device and the type of the held information, and

the characteristic extraction means estimates at least one of the type of the function and the type of the held information from the information indicating at least one of the specification and the application of the target device, and determines the device item indicating at least one of the function and the type of the held information estimated, from the device item predetermined.

### (Supplementary Note 10)

The diagnosis support device according to Supplementary Note 4, wherein

the information of the target device includes information of a management entity that manages the target device,

the security item includes a management entity item indicating a matter defined for the information of the management entity, and

the characteristic extraction means extracts information indicating the management entity item indicating the information of the management entity as the device characteristic from the management entity item predetermined, by using the information of the target device.

### (Supplementary Note 11)

The diagnosis support device according to Supplementary Note 10, wherein

the information of the management entity includes any one of information indicating an attribute of the management entity, information of a security event that has occurred in a management target managed by the management entity in the past, information indicating presence or absence of at least one of security authentication received by the management entity and a security qualification held by the management entity, and information of a business field of the management entity or an organization to which the management entity belongs.

### (Supplementary Note 12)

A diagnosis support method including:

extracting a device characteristic indicating information related to security of a target device from information of the target device; and

determining, from the device characteristic, a magnitude of a device risk that is a risk that may exist in the target device, based on a magnitude of a risk for each security item that is a predetermined item related to security; and

outputting a magnitude of the device risk.

### (Supplementary Note 13)

The diagnosis support method according to Supplementary Note 12, further including:

extracting a diagnosis procedure for diagnosing an actual state of a risk in the target device; and

outputting information of the diagnosis procedure extracted.

### (Supplementary Note 14)

The diagnosis support method according to Supplementary Note 13, further including:

extracting the device characteristic from information of each of a plurality of target devices;

determining the device risk for each of the plurality of target devices; and

outputting the magnitude of the device risk of the plurality of target devices and the information of the diagnosis procedure in order of the magnitude of the device risk.

### (Supplementary Note 15)

The diagnosis support method according to any one of Supplementary Notes 12 to 14, further including:

extracting the device characteristic indicated by the security item indicating a matter related to security from the information of the target device; and

determining the device risk from the device characteristic by using information of an item risk indicating a security risk that may exist, the security risk being defined for a state of the security item.

### (Supplementary Note 16)

The diagnosis support method according to Supplementary Note 15, further including

determining a statistical value of a magnitude of the item risk of the security item specified, as the magnitude of the device risk.

### (Supplementary Note 17)

The diagnosis support method according to Supplementary Note 15, wherein

the information of the target device includes information indicating at least one of a result of a scan of vulnerability of the target device and a result of checking a setting of the target device, and

the security item includes a guideline item indicating a matter to be adhered to, the matter being defined in a security guideline, the diagnosis support method further including

extracting, as the device characteristic, information indicating the guideline item that is not adhered to in the target device among guideline items by using the information of the target device.

### (Supplementary Note 18)

The diagnosis support method according to Supplementary Note 17, further including

specifying an influence of at least one of the vulnerability indicating that the result of the scan exists and the setting indicated by the result of the checking, and setting the guideline item related to the influence as the guideline item that is not adhered to.

### (Supplementary Note 19)

The diagnosis support method according to Supplementary Note 15, wherein

the information of the target device includes information indicating at least one of a type of a function of the target device and a type of held information that is information to be held, and

the security item includes a device item indicating a matter defined for at least one of the type of the function and the type of the held information, the diagnosis support method further including

extracting information indicating the device item indicating at least one of the type of the function of the target device and the type of the held information among the device item as the device characteristic by using the information of the target device.

### (Supplementary Note 20)

The diagnosis support method according to Supplementary Note 19, wherein

the information of the target device includes information indicating at least one of a specification and an application of the target device as the information indicating at least one of the type of the function of the target device and the type of the held information, the diagnosis support method further including

estimating at least one of the type of the function and the type of the held information from the information indicating at least one of the specification and the application of the target device, and determining the device item indicating at least one of the function and the type of the held information estimated, from the device item predetermined.

### (Supplementary Note 21)

The diagnosis support method according to Supplementary Note 15, wherein

the information of the target device includes information of a management entity that manages the target device, and

the security item includes a management entity item indicating a matter defined for the information of the management entity, the diagnosis support method further including

extracting information indicating the management entity item indicating the information of the management entity as the device characteristic from the management entity item predetermined, by using the information of the target device.

### (Supplementary Note 22)

The diagnosis support method according to Supplementary Note 21, wherein

the information of the management entity includes any one of information indicating an attribute of the management entity, information of a security event that has occurred in a management target managed by the management entity in the past, information indicating presence or absence of at least one of security authentication received by the management entity and a security qualification held by the management entity, and information of a business field of the management entity or an organization to which the management entity belongs.

### (Supplementary Note 23)

A program for causing a computer to execute:

characteristic extraction processing of extracting a device characteristic indicating information related to security of a target device from information of the target device;

determination processing of determining, from the device characteristic, a magnitude of a device risk that is a risk that may exist in the target device, based on a magnitude of a risk for each security item that is a predetermined item related to security; and

output processing of outputting a magnitude of the device risk.

### (Supplementary Note 24)

The program according to Supplementary Note 23, wherein

the program further causes a computer to execute

procedure extraction processing of extracting a diagnosis procedure for diagnosing an actual state of a risk in the target device, and

the output processing outputs information of the diagnosis procedure extracted.

### (Supplementary Note 25)

The program according to Supplementary Note 24, wherein

the characteristic extraction processing extracts the device characteristic from information of each of a plurality of target devices,

the determination processing determines the device risk of each of the plurality of target devices, and

the output processing outputs the magnitude of the device risk of the plurality of target devices and the information of the diagnosis procedure in order of the magnitude of the device risk.

### (Supplementary Note 26)

The program according to any one of Supplementary Notes 23 to 25, wherein

the characteristic extraction processing extracts the device characteristic indicated by the security item indicating a matter related to security from the information of the target device, and

the determination processing determines the device risk from the device characteristic by using information of an item risk indicating a security risk that may exist, the security risk being defined for a state of the security item.

### (Supplementary Note 27)

The program according to Supplementary Note 26, wherein

the determination processing determines a statistical value of a magnitude of the item risk of the security item specified, as the magnitude of the device risk.

### (Supplementary Note 28)

The program according to Supplementary Note 26, wherein

the information of the target device includes information indicating at least one of a result of a scan of vulnerability of the target device and a result of checking a setting of the target device,

the security item includes a guideline item indicating a matter to be adhered to, the matter being defined in a security guideline, and

the characteristic extraction processing extracts, as the device characteristic, information indicating the guideline item that is not adhered to in the target device among guideline items by using the information of the target device.

### (Supplementary Note 29)

The program according to Supplementary Note 28, wherein

the characteristic extraction processing specifies an influence of at least one of the vulnerability indicating that the result of the scan exists and the setting indicated by the result of the checking, and sets the guideline item related to the influence as the guideline item that is not adhered to.

### (Supplementary Note 30)

The program according to Supplementary Note 26, wherein

the information of the target device includes information indicating at least one of a type of a function of the target device and a type of held information that is information to be held,

the security item includes a device item indicating a matter defined for at least one of the type of the function and the type of the held information, and

the characteristic extraction processing extracts information indicating the device item indicating at least one of the type of the function of the target device and the type of the held information among the device item as the device characteristic by using the information of the target device.

### (Supplementary Note 31)

The program according to Supplementary Note 30, wherein

the information of the target device includes information indicating at least one of a specification and an application of the target device as the information indicating at least one of the type of the function of the target device and the type of the held information, and

the characteristic extraction processing estimates at least one of the type of the function and the type of the held information from the information indicating at least one of the specification and the application of the target device, and determines the device item indicating at least one of the function and the type of the held information estimated, from the device item predetermined.

### (Supplementary Note 32)

The program according to Supplementary Note 26, wherein

the information of the target device includes information of a management entity that manages the target device,

the security item includes a management entity item indicating a matter defined for the information of the management entity, and

the characteristic extraction processing extracts information indicating the management entity item indicating the information of the management entity as the device characteristic from the management entity item predetermined, by using the information of the target device.

### (Supplementary Note 33)

The program according to Supplementary Note 32, wherein

the information of the management entity includes any one of information indicating an attribute of the management entity, information of a security event that has occurred in a management target managed by the management entity in the past, information indicating presence or absence of at least one of security authentication received by the management entity and a security qualification held by the management entity, and information of a business field of the management entity or an organization to which the management entity belongs.

### (Supplementary Note 34)

A diagnosis support system including:

the diagnosis support device according to any one of Supplementary Notes 1 to 3; and

a large language model server that provides a service using a large language model, wherein

the diagnosis support device includes

an extraction instruction means for transmitting, to the large language model server, an instruction to execute processing of extracting at least a part of the device characteristic from at least a part of the information of the target device,

the large language model server extracts at least a part of the device characteristic from at least a part of the information of the target device by using the large language model in response to receiving the instruction, and

the determination means determines the magnitude of the device risk from the device characteristic including at least the part extracted by the large language model server.

While the present invention has been particularly shown and described with reference to example embodiments thereof, the present invention is not limited to these example embodiments. It will be understood by those of ordinary skill in the art that various changes in form and details may be made therein without departing from the spirit and scope of the present invention as defined by the claims.

What is claimed is:

1. A diagnosis support device comprising:
at least one memory storing a set of instructions; and
at least one processor configured to execute the set of instructions to:
extract a device characteristic indicating information related to security of a target device from information of the target device;
determine, from the device characteristic, a magnitude of a device risk based on a magnitude of a risk of a security item that is a predetermined item related to security, the device risk being a risk that is capable of existing in the target device; and
output a magnitude of the device risk.

2. The diagnosis support device according to claim 1, wherein
the at least one processor is further configured to execute the instructions to:
extract a diagnosis procedure for diagnosing an actual state of a risk in the target device; and
output information of the diagnosis procedure that is extracted.

3. The diagnosis support device according to claim 2, wherein
the at least one processor is further configured to execute the instructions to:
extract the device characteristic from information of each of a plurality of target devices;
determine the device risk of each of the plurality of target devices; and
output the magnitude of the device risk and the information of the diagnosis procedure of each of the plurality of target devices in order of the magnitude of the device risk.

4. The diagnosis support device according to claim 1, wherein
the at least one processor is further configured to execute the instructions to:
extract, from the information of the target device, the device characteristic indicated by the security item indicating a matter related to security; and
determine the device risk from the device characteristic by using information of an item risk indicating a security risk that is capable of existing, the security risk being defined for a state of the security item.

5. The diagnosis support device according to claim 4, wherein
the at least one processor is further configured to execute the instructions to
determine, as the magnitude of the device risk, a statistical value of a magnitude of the item risk of the security item.

6. The diagnosis support device according to claim 4, wherein
the information of the target device includes information indicating at least any of a result of a scan of vulnerability of the target device and a result of checking a setting of the target device,
the security item includes a guideline item indicating a matter to be adhered to, the matter being defined in a security guideline, and
the at least one processor is further configured to execute the instructions to
extract, as the device characteristic, information indicating the guideline item that is not adhered to in the target device in the guideline item by using the information of the target device.

7. The diagnosis support device according to claim 6, wherein
the at least one processor is further configured to execute the instructions to:
specify an influence of at least any of the vulnerability indicating that the result of the scan exists and the setting indicated by the result of the checking; and
set the guideline item related to the influence as the guideline item that is not adhered to.

8. The diagnosis support device according to claim 4, wherein
the information of the target device includes information indicating at least any of a type of a function of the target device and a type of held information that is information held by the target device,
the security item includes a device item indicating a matter defined for at least any of the type of the function and the type of the held information, and
the at least one processor is further configured to execute the instructions to
extract information indicating the device item indicating at least any of the type of the function of the target device and the type of the held information in the device item as the device characteristic by using the information of the target device.

9. The diagnosis support device according to claim 8, wherein
the information of the target device includes information indicating at least any of a specification and a purpose of the target device as the information indicating at least any of the type of the function of the target device and the type of the held information, and
the at least one processor is further configured to execute the instructions to:
estimate at least any of the type of the function and the type of the held information from the information indicating at least one of the specification and the purpose of the target device; and
determine, from the device item that is predetermined, the device item indicating the estimated at least any of the function and the type of the held information.

10. The diagnosis support device according to claim 4, wherein
the information of the target device includes information of a management entity that manages the target device,
the security item includes a management entity item indicating a matter defined for the information of the management entity, and
the at least one processor is further configured to execute the instructions to
extract, from the management entity item that is predetermined, information indicating the management entity item indicating the information of the management entity as the device characteristic by using the information of the target device.

11. The diagnosis support device according to claim 10, wherein
the information of the management entity includes any of information indicating an attribute of the management entity, information of a security event that has occurred in a management target managed by the management entity in a past, information indicating presence or absence of at least any of security authentication received by the management entity and a security qualification held by the management entity, and information of a business field of the management entity or an organization to which the management entity belongs.

12. A diagnosis support system including the diagnosis support device according to claim 1, the diagnosis support system comprising
a large language model server that provides a service using a large language model, wherein
the at least one processor is further configured to execute the instructions to transmit, to the large language model server, an instruction to execute processing of extracting at least a part of the device characteristic from at least a part of the information of the target device,
the large language model server extracts at least a part of the device characteristic from at least a part of the information of the target device by using the large language model in response to receiving the instruction, and
the at least one processor is further configured to execute the instructions to determine the magnitude of the device risk from the device characteristic including at least the part extracted by the large language model server.

13. A diagnosis support method comprising:
extracting a device characteristic indicating information related to security of a target device from information of the target device;
determining, from the device characteristic, a magnitude of a device risk based on a magnitude of a risk of a security item that is a predetermined item related to security, the device risk being a risk that may exist in the target device; and
outputting a magnitude of the device risk.

14. The diagnosis support method according to claim 13, further comprising:
extracting a diagnosis procedure for diagnosing an actual state of a risk in the target device; and
outputting information of the diagnosis procedure that is extracted.

15. The diagnosis support method according to claim 14, further comprising:
extracting the device characteristic from information of each of a plurality of target devices;
determining the device risk of each of the plurality of target devices: and
outputting the magnitude of the device risk and the information of the diagnosis procedure of each of the plurality of target devices in order of the magnitude of the device risk.

16. The diagnosis support method according to claim 13, further comprising:
extracting, from the information of the target device, the device characteristic indicated by the security item indicating a matter related to security; and
determining the device risk from the device characteristic by using information of an item risk indicating a security risk that is capable of existing, the security risk being defined for a state of the security item.

17. The diagnosis support method according to claim 16, further comprising
determining, as the magnitude of the device risk, a statistical value of a magnitude of the item risk of the security item.

18. The diagnosis support method according to claim 16, wherein
the information of the target device includes information indicating at least any of a result of a scan of vulnerability of the target device and a result of checking a setting of the target device,
the security item includes a guideline item indicating a matter to be adhered to, the matter being defined in a security guideline, and
the diagnosis support method further comprises
extracting, as the device characteristic, information indicating the guideline item that is not adhered to in the target device in the guideline item by using the information of the target device.

19. The diagnosis support method according to claim 18, further comprising:
specifying an influence of at least any of the vulnerability indicating that the result of the scan exists and the setting indicated by the result of the checking; and
setting the guideline item related to the influence as the guideline item that is not adhered to.

20. A non-transitory computer readable storage medium storing a program for causing a computer to execute:
characteristic extraction processing of extracting a device characteristic indicating information related to security of a target device from information of the target device;
determination processing of determining, from the device characteristic, a magnitude of a device risk based on a magnitude of a risk of a security item that is a predetermined item related to security, the device risk being a risk that is capable of existing in the target device; and
output processing of outputting a magnitude of the device risk.
